(19) United States
(12) Patent Application Publication
(10) Pub. No.: US 2006/0178799 A1
(43) Pub. Date: Aug. 10, 2006

(54) Enhanced roll control system

(76) Inventors: John F. Hoying, Centerville, OH (US); David A. Shal, Bellbrook, OH (US); Scott A. Stacey, Centerville, OH (US); Sinisa Mandich, Munich (DE)

Correspondence Address: Delphi Technologies, Inc.;M/C 480-410-202, P.O. Box 5052, Troy, MI, 48007-5052, US

(21) Appl. No.: 11/054,867

(22) Filed: Feb. 10, 2005

(51) Int. Cl. G06F 19/00

(52) U.S. Cl. 701/70; 340/429; 340/440

(57) ABSTRACT

An enhanced roll control system for a vehicle having a controlled damping system and a roll control system. In one aspect, the enhanced roll control system may include a first controller for controlling the roll control system, a second controller for controlling the controlled damping system, and at least one sensor positioned at each corner of the vehicle, the position sensors being in communication with the first and second controllers, wherein signals from the position sensors contribute to the control of the controlled damping system and the roll control system.

### BACKGROUND

The present invention is directed to a controlled suspension system and, more particularly, to an enhanced roll control system for a vehicle.

Modem vehicles, such a passenger cars, trucks, vans and the like, typically employ various suspension systems. The suspension systems respond to various road and driving conditions in an effort to minimize the effect of such conditions on the occupants of the vehicle.

Suspension systems may be autonomous or controlled. An autonomous suspension system does not include a controller and may be as simple as a spring mounted between the wheel and body of a vehicle. A controlled suspension system typically includes a controller (or electronic control unit) that receives signals from various sensors and, based on the signals, generates and communicates a control signal to an output device.

FIG. 1 is a schematic illustration of a typical controlled suspension system having a vehicle stability system, a controlled damping system and a roll control system.

The vehicle stability system is a brake-based system that activates one or more wheel brakes, with or without driver intervention, to provide understeer and oversteer correction, thereby enhancing the vehicle's stability. The vehicle stability system typically includes a brake controller 100 in communication with input devices 102 (via input line 103) and output devices 104 (via output lines 105, 107). The input devices 102 may include a yaw rate sensor 109, a lateral accelerometer 106, a steering sensor 108 (which provides a steering angle signal), a master cylinder pressure sensor 110 and a wheel speed sensor 112 (which provides a vehicle speed signal). The output devices 104 may include brake actuators 114 and a variable assist to the power steering unit 116. The brake controller 100 generates a control signal to the output devices 104 based on signals received from the input devices 102.

The brake controller 100 may be in communication with a powertrain controller 118 via lines 120, 122. Line 120 provides the brake controller 100 with a signal indicating the actual torque being produced by the powertrain (not shown) and line 122 provides the powertrain controller 118 with a signal indicating the required torque (to achieve the desired control) as determined by the brake controller 100. Thus, the powertrain controller 118 may control the amount of torque being supplied by the powertrain, thereby contributing to the control of the vehicle stability system.

The brake controller 100 may be in communication with a damper controller 124 of the controlled damping system via lines 126, 128. The damper controller 124 may provide the brake controller 100 with signals indicating the normal forces applied at the left front (via line 126) and right front (via line 128) of the vehicle. Thus, the brake controller 100 may adjust the braking frequency when signals from the damper controller 124 indicate that the wheels are moving normal to the vehicle (i.e., up and down due to bumps in the road).

The controlled damping system typically includes a damper controller 124 in communication with relative position sensors 127 (via line 128) positioned at each corner of the vehicle, controlled dampers 130 (via line 132) and, optionally, a pneumatic leveling system 134 (via line 136). The controller 124 generates a control signal for controlling the dampers 130 (and the leveling system 134) based on signals received from the position sensors 127. The damper controller 124 may include additional control inputs such as the vehicle speed (via line 138 from the brake controller 100), the steering angle (via line 140 from the brake controller 100), and vehicle lift and dive (via line 142 from the powertrain controller).

Thus, the controlled damping system controls the heave (i.e., up and down movement), pitch (i.e., front and back movement), and roll (i.e., side-to-side movement) of the vehicle by controlling the dampers 130.

The roll control system, also known as the active stabilizer bar system, is a hydraulic system that is fully active. The roll control system typically includes a roll controller 144 in communication with inputs 146 (via line 147) and controlled actuators (i.e., outputs) 148 (via line 149). The inputs 146 typically include a second lateral accelerometer 150 and actuator pressure sensors 152. The system may include one actuator 148 (i.e., a 1-channel-1-axle system) or two actuators 148 (i.e., a 1-channel or a 2-channel system). Additional inputs may include the vehicle speed (via line 154 from the brake controller 100) and the steering angle (via line 156 from the brake controller 100).

Thus, the roll control system pressurizes and depressurizes the actuators 148 according to control signals generated by the roll controller 144 in response to inputs 146. The actuators 148 move the stabilizer bar 151, thereby maintaining the vehicle at a level position when the vehicle enters a turn (i.e., rolls).

### SUMMARY

One aspect of the enhanced roll control system provides a method for verifying whether a vehicle having a controlled damping system and a roll control system is at a proper trim height and includes the steps of providing the vehicle with at least one position sensor at each corner of the vehicle, wherein each of the position sensors is associated with the controlled damping system, obtaining a position measurement from each of the position sensors, and determining whether the vehicle is at a proper trim height based upon the position measurements.

Another aspect of the enhanced roll control system may include a first controller for controlling the roll control system, a second controller for controlling the controlled damping system, and at least one sensor positioned at each corner of the vehicle, the position sensors being in communication with the first and second controllers, wherein signals from the position sensors contribute to the control of the controlled damping system and the roll control system.

In another aspect of the enhanced roll control system, the control system for a vehicle may include a controlled damping system, a controlled braking system and a roll control system. The enhanced roll control system may include a roll controller for controlling the enhanced roll control system, at least one position sensor associated with the controlled damping system, wherein signals from the position sensor are communicated to the roll controller, and a yaw rate sensor, a first accelerometer and a steering angle sensor associated with the controlled braking system, wherein signals from at least one of the yaw rate sensor, first accelerometer and steering angle sensor are communicated to the roll controller, wherein the roll controller generates control signals for controlling the enhanced roll control system based at least in part on signals received from at least one of the position sensor, yaw rate sensor, first accelerometer and steering angle sensor.

In another aspect of the enhanced roll control system, the control system may include a roll controller for controlling the enhanced roll control system and a mass change sensor, wherein signals from the mass change sensor are communicated to the roll controller, wherein the roll controller generates control signals for controlling the enhanced roll control system based at least in part on signals received from the mass change sensor.

Other embodiments, objects and advantages of the enhanced roll control system will be apparent from the following description, the accompanying drawings and the appended claims.

### BRIEF DESCRIPTION OF THE DRAWINGS

FIG. 1 is a schematic view of a prior art controlled suspension system;

FIG. 2 is a schematic view of the enhanced roll control system; and

FIG. 3 is a schematic view of vehicle including the enhanced roll control system.

### DETAILED DESCRIPTION

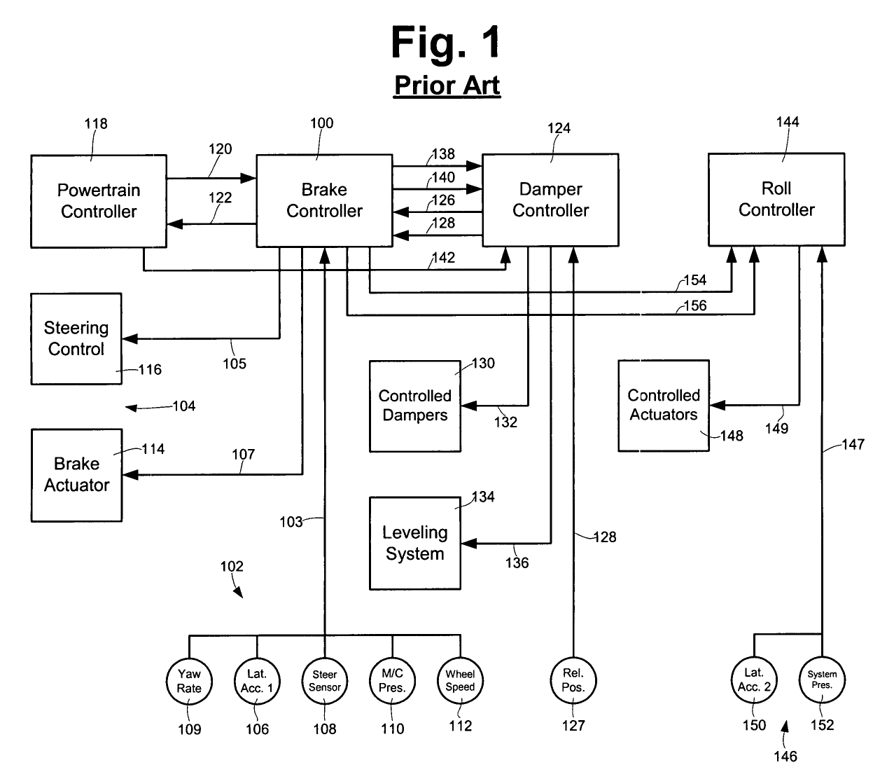

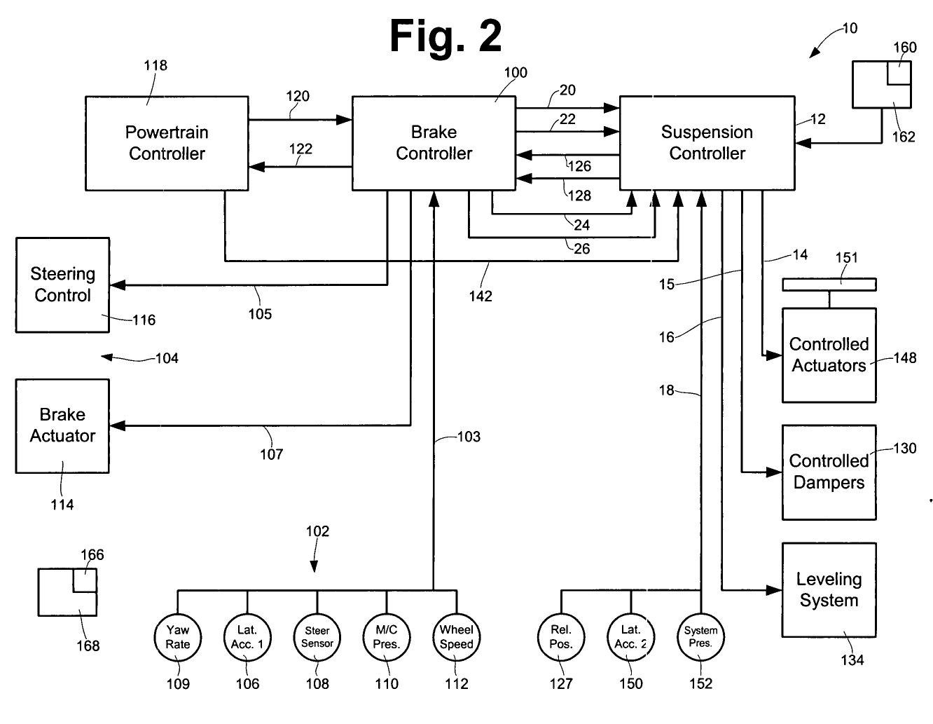

The enhanced roll control system, generally designated 10 in FIG. 2, may include a powertrain controller 118, a brake controller 100 and a suspension controller 12. The powertrain controller 118 and brake controller 100 may include the same inputs and outputs as in FIG. 1. However, according to one embodiment, a suspension controller 12 may control the controlled damping system and the roll control system.

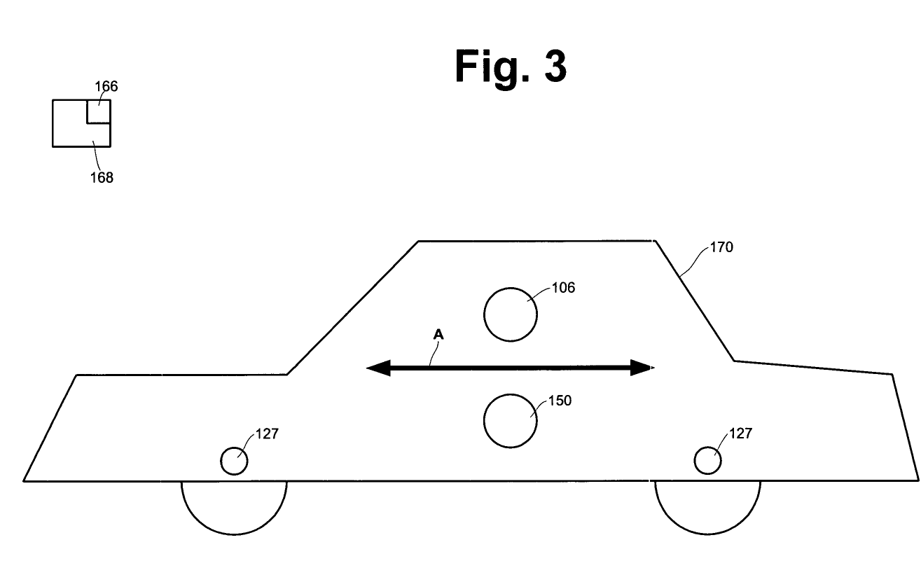

In one aspect, the suspension controller 12 may generate control signals for controlling the controlled actuators 148 (via line 14), the controlled dampers 130 (via line 15) and the leveling system 134 (via line 16) based on a number of inputs 18, 20, 22, 24, 26, 142. Input 18 may include a position signal from relative position sensors 127, an acceleration signal from a second lateral accelerometer 150 and a pressure signal from actuator pressure sensors 152. Inputs 20, 22, 24, 26 may be communicated from the brake controller 100 and include a vehicle speed signal (input 20), a steering angle signal (input 22), a first lateral acceleration signal (input 24) and a yaw rate signal (input 26). Input 142 may include vehicle lift and dive signals from the powertrain controller 118. It should be understood that the relative position sensors 127 may be positioned such that a position sensor 127 is located at or near each corner or wheel of a vehicle 170 (see FIG. 3) such as a passenger car.

The suspension controller 12 may include a single electronic control unit having an algorithm for controlling both the damping system and the roll control system. Alternatively, the suspension controller 12 may include two (or more) electronic control units (e.g., one for the damper system and one for the roll control system), wherein each individual electronic control unit includes each of the inputs 18, 20, 22, 24, 26, 142.

Thus, the damping system and the roll control system each may be provided with additional inputs that may be used to generate control signals without the need for purchasing, supplying and/or installing additional sensors. For example, the roll control system may benefit by receiving signals from the relative position sensor 127, which, in the prior art, only provided insight to the controlled damping system, and the first lateral accelerometer 106 and yaw rate sensor 109, which, in the prior art, only provided insight to the vehicle stability system.

According to another aspect of the enhanced roll control system, the position sensors 127 may measure the relative position of an associated vehicle body (not shown) with respect to the wheels (not shown) that may be at each corner of the vehicle 170. The suspension controller 12 may then determine whether the vehicle 170 is at a proper trim height based on the measurements of the position sensors 127. Thus, for a vehicle having the enhanced roll control system, a vehicle manufacturer may quickly and easily determine whether the vehicle is at a proper trim height prior to the vehicle leaving the manufacturing facility.

According to an alternative embodiment, the relative position sensors 127 may be in communication with an external (of the vehicle) controller 166 such as an operating unit 168 in a manufacturing facility. When the relative position sensors 127 indicate that the vehicle 170 is at a proper trim height, a positive signal may be sent to the operating unit. However, when the sensors 127 indicate that the vehicle 170 is not at a proper trim height, a signal may be sent to the operating unit that indicates that the vehicle requires further attention, which in turn generates a warning signal.

According to another embodiment, the enhanced roll control system may include an additional input from a mass change sensor 160 from the vehicle's pneumatic leveling system 162. In the prior art, the mass change sensors typically were used to level the vehicle. However, according to the present invention, the mass change sensors may also be used as additional inputs to the suspension controller 12 (i.e., the damping system and roll control system) for generating a control signal to the controlled actuators 148 and dampers 130.

According to another embodiment, the suspension controller 12 of the enhanced roll control system may convert the acceleration signals from the first and second lateral accelerometers 106, 150 into a roll velocity signal such that the controlled damping system may use the roll velocity signal as an additional input when generating a control signal for the controlled dampers. In one embodiment, shown in FIG. 3, the accelerometers 106, 150 are positioned such that the first accelerometer 106 is positioned above the vehicle roll axis A and the second accelerometer 150 is positioned below the vehicle roll axis A. Thus, when the vehicle 170 is in a roll, the first accelerometer 106 detects an acceleration in a first direction and the second accelerometer 150 detects an acceleration in a second, opposite, direction.

Although the enhanced roll control system is shown and described with respect to certain embodiments, it is to be understood that modifications may be made thereto. The enhanced roll control system includes all such modifications and is limited only by the scope of the claims.

What is claimed is:

1. A method for verifying whether a vehicle having a controlled damping system and a roll control system is at a proper trim height comprising the steps of:
providing said vehicle with at least one position sensor at each corner of said vehicle, wherein each of said position sensors is associated with said controlled damping system;
obtaining a position measurement from each of said position sensors; and
determining whether said vehicle is at a proper trim height based on said position measurements.

2. The method of claim 1 wherein said determining step is performed by an electronic control unit.

3. The method of claim 2 wherein said electronic control unit is external of said vehicle.

4. The method of claim 2 wherein said electronic control unit is mounted on said vehicle.

5. The method of claim 1 further comprising the step of generating a warning signal when said vehicle is not at said proper trim height.

6. The method of claim 1 wherein said determining step is performed prior to said vehicle leaving an assembly plant.

7. The method of claim 1 wherein said position sensors are relative body to wheel sensors.

8. An enhanced roll control system for a vehicle having a controlled damping system and a roll control system, said enhanced roll control system comprising:
a first controller for controlling said roll control system;
a second controller for controlling said controlled damping system; and
at least one position sensor positioned at each corner of said vehicle, said position sensors being in communication with said first and second controllers, wherein signals from said position sensors contribute to the control of said controlled damping system and said roll control system.

9. The system of claim 8 wherein said first controller and second controller are part of a single electronic control unit.

10. The system of claim 9 further comprising a first accelerometer and a second accelerometer, each accelerometer supplying an acceleration signal to said electronic control unit.

11. The system of claim 10 wherein said first accelerometer is positioned below a roll axis of said vehicle and said second accelerometer is positioned above said roll axis.

12. The system of claim 8 wherein said roll control system is a 2-channel or 1-channel-1-axle roll control system.

13. An enhanced roll control system for a vehicle having a controlled damping system, a controlled braking system and a roll control system, said enhanced roll control system comprising:
a roll controller for controlling said enhanced roll control system;
at least one position sensor associated with said controlled damping system, wherein signals from said position sensor are communicated to said roll controller; and
a yaw rate sensor, an first accelerometer and a steering angle sensor associated with said controlled braking system, wherein signals from at least one of said yaw rate sensor, first accelerometer and steering angle sensor are communicated to said roll controller,
wherein said roll controller generates control signals for controlling said enhanced roll control system based at least in part on signals received from at least one of said position sensor, yaw rate sensor, first accelerometer and steering angle sensor.

14. The system of claim 13 further comprising at least one actuator in communication with said roll controller, said actuator being responsive to said control signals.

15. The system of claim 14 further comprising a stabilizer bar connected to said actuator.

16. The system of claim 13 wherein said roll control system is selected from the group consisting of a 1-channel and a 2-channel roll control system.

17. The system of claim 13 further comprising a second accelerometer in communication with said roll controller.

18. The system of claim 17 wherein said first accelerometer is positioned below a roll axis of said vehicle and said second accelerometer is positioned above said roll axis.

19. The system 14 further comprising a pressure sensor adapted to monitor a pressure within said actuator.

20. An enhanced roll control system comprising:
a roll controller for controlling said enhanced roll control system; and
a mass change sensor, wherein signals from said mass change sensor are communicated to said roll controller,
wherein said roll controller generates control signals for controlling said enhanced roll control system based at least in part on signals received from said mass change sensor.

21. The system of claim 20 wherein said mass change sensor is associated with a pneumatic leveling system.

22. The system of claim 20 wherein said control signals provide oversteer and understeer contributions.
